(19) United States
(12) Patent Application Publication
(10) Pub. No.: US 2025/0086685 A1
(43) Pub. Date: Mar. 13, 2025

(54) AUTOMATED ITEM INFORMATION ASSISTANCE FROM IMAGES

(71) Applicant: Maplebear Inc., San Francisco, CA (US)

(72) Inventors: Shubhanshu Mishra, Woodridge, IL (US); Gia Young, Livermore, CA (US); Jennie Morgan Burger, Tucson, AZ (US); Joseph Olivier, San Bruno, CA (US); Brent Luna, Oakland, CA (US); Yuanzheng Zhu, Smyrna, GA (US); Mackenzie Cala, San Francisco, CA (US); Armand Raquel-Santos, San Rafael, CA (US); David Zandman, San Francisco, CA (US); Mia Martinez Barnett, Chicago, IL (US); Callie Bleckner, Oakland, CA (US); Mohammad Abdul-Rahim, San Francisco, CA (US)

(21) Appl. No.: 18/243,600

(22) Filed: Sep. 7, 2023

(51) Int. Cl. G06Q 30/0601; G06V 20/50

(52) U.S. Cl. CPC G06Q 30/0617; G06Q 30/0641; G06V 20/50; G06F 40/40

(57) ABSTRACT

An online concierge system assists users in identifying additional information about items in an image. Image regions are identified in the image that may correspond to unknown items and an item search space is determined for detecting items in the image regions based on a context of the image, such as items in a warehouse or a list of items delivered to a customer. The identified items are used to retrieve relevant item information that is included in a prompt for a language model to extract relevant information for the item. As such, the process may automatically process the image into relevant textual information about the pictured items. Applications may be used to assist vision-impaired users in distinguishing delivered items or quickly identifying and evaluating relevant information about items.

### BACKGROUND

Online concierge systems assist customers in selecting items for an order to be fulfilled by a shopper at a physical warehouse. When ordered items are not in stock, these systems may provide suggestions as a replacement to the ordered item. However, typically the shopper at the physical warehouse has a limited amount of time to complete the order, such that selecting an appropriate replacement item may be difficult while the shopper is at the warehouse. In particular, even when the shopper can provide possible replacements (e.g., to the customer placing the order), the customer may require additional time to evaluate the possible replacements that are actually in stock and determine which is a suitable replacement item. For example, a shopper may provide a picture of the area of potential replacement items and ask the customer to select a replacement. Customers may need to know additional information beyond what is available in the picture to determine whether to order the item. This problem may be compounded by users who cannot readily determine information from the image, such as users with vision difficulties or who may be partially or fully blind. The picture of the area may also include additional items that are not suitable replacements for the ordered item, such that information about all items in the image may provide significant excess information to the customer. In another context, users may also benefit from surfacing relevant information from other images. For example, a vision-impaired customer receiving an order with several different items of a similar size (e.g., different flavors of a similarly-packaged product, or different types of similarly-packaged milk) may not be able to readily determine, based on the item's packaging, which physical item is which. As such, approaches are needed for effectively evaluating items from an image and surfacing relevant information about the items. Approaches are also needed for determining items in an image (e.g., as candidate replacements for an ordered item) and aiding in surfacing relevant information about the items readily. In the replacement item context, information about the item for selection of a replacement should be efficient to reduce the amount of time that the shopper is at the warehouse.

### SUMMARY

In accordance with one or more aspects of the disclosure, an online concierge system identifies items in an image and coordinates relevant information retrieval related to the items with a language model. Portions of the image corresponding to different items may be determined and used to identify the items with respect to a context. The items may be identified from a list of possible items based on the particular context, such as an item catalog of items available at a warehouse or items recently delivered to a customer. Information about the identified items may then be retrieved and used as part of a query to a language model to surface relevant information about the items. The information may be used, for example, to distinguish different items in the image or to provide additional information for a customer to select a replacement item for an item that is out of stock. The query to the language model may be used to determine answers that summarize information about the items, identify the aspects of items that may be of most interest, to compare items (e.g., information about items in the image or an item in the image and an item that was unavailable for delivery), or to determine related questions that a user may ask about the identified items. In general, the identification of items from the image and use of the language model may be applied to interpret the image and provide salient information in a textual format that may be provided to a user as a chat message or converted to audio with a text-to-speech process, enabling users (particularly those who have limited vision) to quickly and effectively understand relevant context from effective processing of the item information by the language model, avoiding laborious review of complete information about the item(s).

In one or more embodiments, an online concierge system may select a shopper to fulfill an order at a warehouse. At the warehouse, a shopper determines that an item ordered by a customer is unavailable at a warehouse. The shopper may use the shopper's device to capture an image of an area of the warehouse with items that may be replacements for the ordered item and the device sends the image to the online concierge system. The online concierge system segments the image to identify regions of the image that may correspond to items. The regions are input to a model to identify items in the image that correspond to items available at the warehouse. As such, the image-based search using the image regions may be confined to searching for matching items from the items available at the warehouse, reducing the search space and improving the likelihood of successful item identification with corresponding item information at the online concierge system.

The items identified in the image may then be evaluated to select relevant items as replacements for the item ordered by the user (i.e., that was not available in the warehouse). The selected items may be based on a replacement item model that scores items with respect to relevance to the replacement item and/or the likelihood that an item is selected by a user as a replacement for the unavailable item. The selected items may then be candidate items for suggestion to the customer as a replacement for the ordered item. Information about the candidate items may then be used to form a query for a language model, such that the language model may generate an output that provides additional information to the customer in selecting a replacement item from the candidate items. An interface is provided to the customer with the possible candidate replacements. Using the text-based output from the language model, the user may interact with the output to determine relevant questions and/or answers related to the replacement item, enabling relevant information about the replacements to be surfaced to the user. As such, the process as a whole enables a shopper to prompt a customer for candidate replacement items with an image, the online concierge system to identify candidate replacement items from the image, and provide salient information for the customer to select a replacement.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart for a method of automated item information assistance from an image, in accordance with one or more embodiments.

FIG. 4 shows an example interface for providing item information assistance for an image related to an order by a user, in accordance with one or more embodiments.

FIGS. 5 and 6 provide an example flow and user interfaces for providing replacement item assistance from an image, in accordance with one or more embodiments.

### DETAILED DESCRIPTION

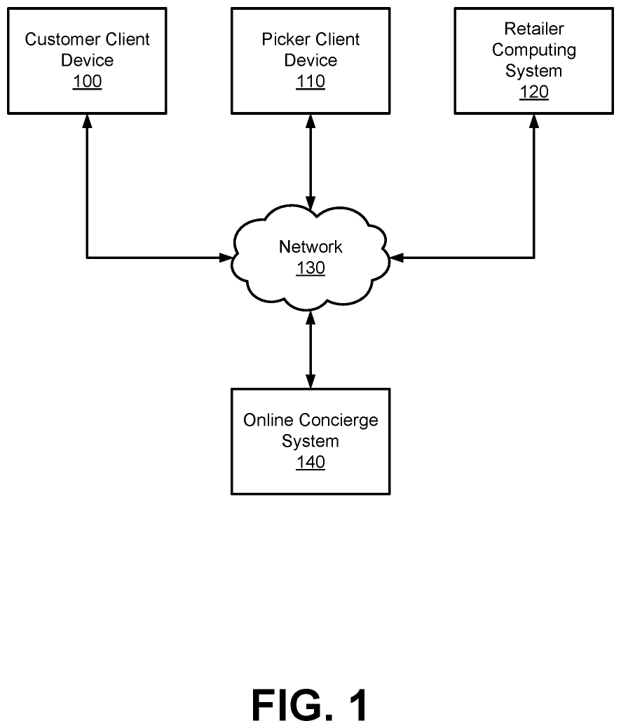

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention. The online concierge system 140 is one system that may implement aspects of the present disclosure. For example, while discussed in the context of the online concierge system 140, image analysis, use of a language model, and surfacing of relevant information for a user (e.g., a vision-impaired user) may be used by additional types of systems for different types of items.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit (SKU) or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

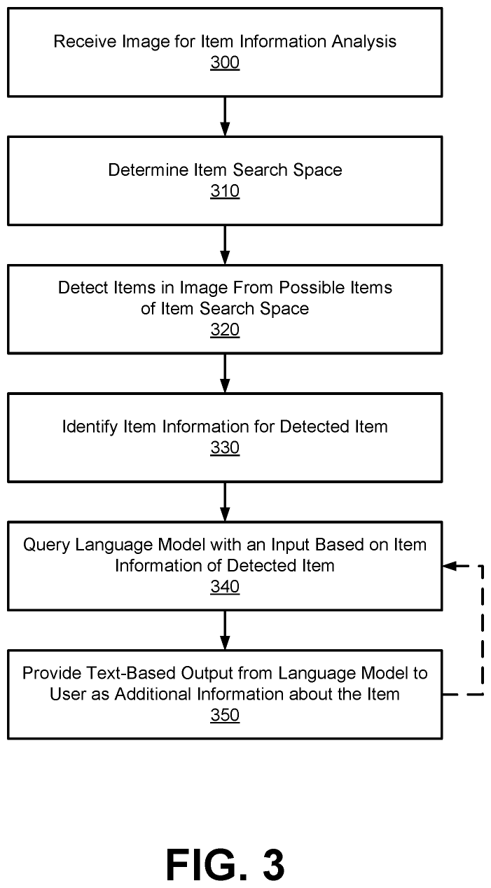

In one or more embodiments, the picker may identify that an item in the order is not available at a retailer. The picker may correspond with the customer, for example via a chat-based interface, to select a replacement item for the item in the order. In some embodiments, the online concierge system 140 may aid in recommending candidate replacement items that may be selected by the picker as a replacement for the ordered item, or as candidate replacement items suggested to the customer for the customer to select. In some instances, the picker may capture an image of the retailer, such as a shelf or other area of the retailer's physical environment that contains items that may be considered as replacement items. For example, when a user orders a specific brand and flavor of ice cream, the picker may operate the picker client device 110 to capture an image of the area of the retailer in which other ice creams are stocked. The image is sent to the online concierge system 140 by the picker client device 110. As discussed further below, the online concierge system 140 may automatically analyze the image to identify items in the image along with relevant information about the items to aid in the selection of a replacement item. In further examples, the online concierge system 140 may provide information about items in an image in other contexts, for example, to aid a customer in identifying items delivered to the customer or to answer questions related to pictured items. Examples of these processes are further discussed below and particularly with respect to FIGS. 3-6.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

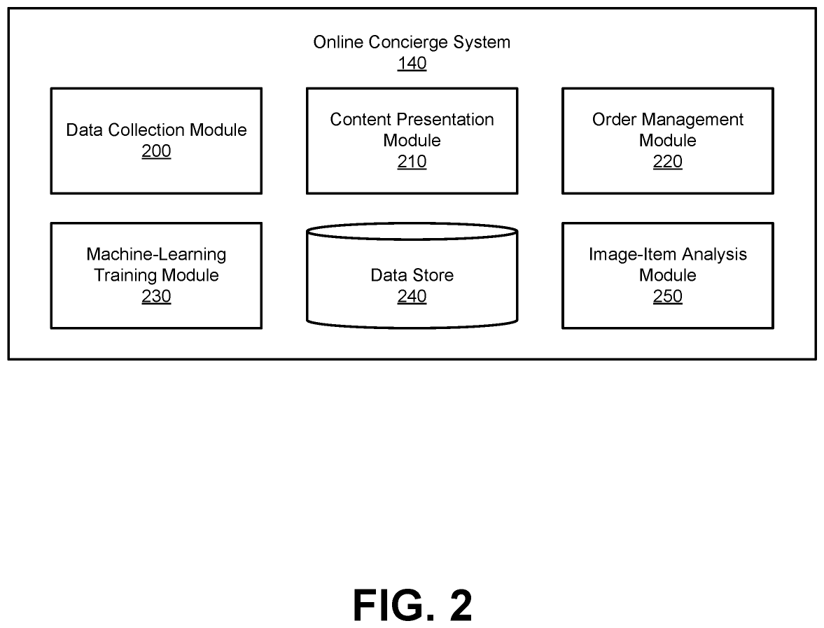

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a data store 240, and an image-item analysis module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of the order. In some embodiments, the order management module 220 computes an estimated time of arrival of the picker to the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, hierarchical clustering, and neural networks. Additional examples also include perceptrons, multilayer perceptrons (MLP), convolutional neural networks, recurrent neural networks, sequence-to-sequence models, generative adversarial networks, and transformers. A machine-learning model may include components relating to these different general categories of model, which may be sequenced, layered, or otherwise combined in various configurations.

Each machine-learning model includes a set of parameters. The set of parameters for a machine-learning model are used to process an input and generate an output. For example, a set of parameters for a linear regression model may include weights that are applied to each input variable in the linear combination that comprises the linear regression model. Similarly, the set of parameters for a neural network may include the respective weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes a set of input data for which machine-learning model generates an output. For example, each training example may include customer data, picker data, item data, or order data. In some cases, the training examples also include a label which represents an expected output (i.e., a desired or intended output) of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model, whereby the machine-learning training module 230 updates parameters of the machine-learning model based on each of the set of training examples. The training examples may be processed together, individually, or in batches. To train a machine-learning model based on a training example, the machine-learning training module 230 applies the machine-learning model to the input data in the training example to generate an output with a current set of parameters. The machine-learning training module 230 scores the output from the machine-learning model using a loss function. A loss function is a function that generates a score for the output of the machine-learning model, such that the score is higher when the machine-learning model performs poorly and lower when the machine learning model performs well. In cases where the training example includes a label, the loss function is also based on the label for the training example. Example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory computer-readable media. The data store 240 uses computer-readable media to store data, and may use databases to organize the stored data.

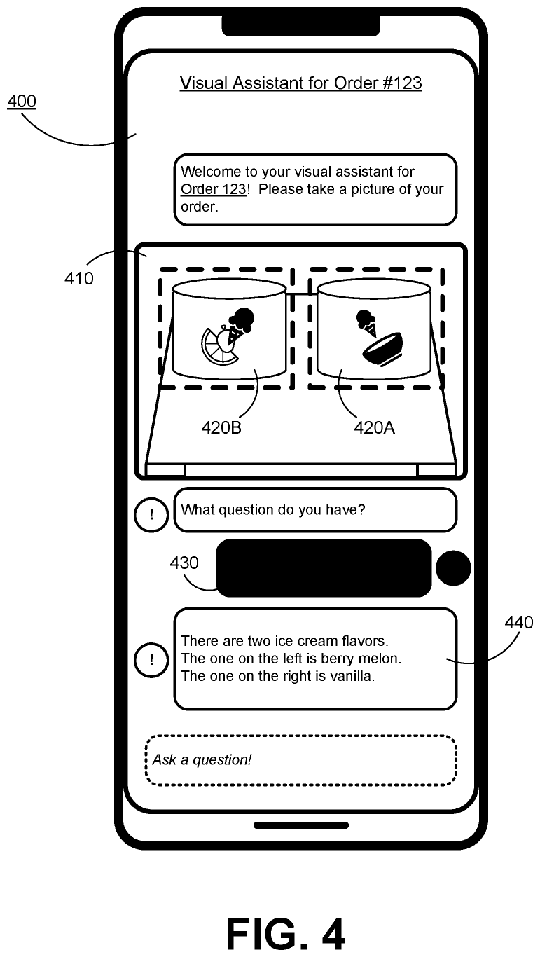

An image-item analysis module 250 provides for identification and analysis of items in an image to provide text-based information for items in an image. In various situations, it may be beneficial to analyze and provide information related to items based on an image. Two examples are discussed below with respect to FIGS. 4-6, particularly relating to item identification for delivered orders and for evaluating replacement items when an ordered item is unavailable. The image-item analysis module 250 receives an image, such as from a picker or a customer, identifies items within the image, and coordinates with a language model to generate text-based information about the items. The output from the language model may then be provided to users (e.g., as a part of an interactive chat-based interface) to provide an intuitive and natural way to obtain relevant information about the items in the image without requiring the user to directly review the item information, and interactions with the interface may be used to provide further prompts to the language model to determine additional information customized to the user's requests. In one or more embodiments, the language model may also be used to generate one or more questions that may be related to the items and, optionally, generate corresponding answers to the question(s). This may be used to guide a user's interaction with the system for obtaining further information about the items. This approach may be particularly useful to aid users who have limited vision, such that information about items may be automatically processed from an image and presented in a textual format with text-to-speech services. These and other features of the image-item analysis module 250 are further discussed below.

In various embodiments, the image-item analysis module 250 interacts with one or more computer models, which may include models trained by the machine-learning training module 230 and stored in the data store 240, and may include models that are trained and/or stored by external services. As such, the image-item analysis module 250 may generate and provide respective inputs and receive respective outputs (“responses”) from the computer models.

As a general overview, the computer models (which may be hosted by the online concierge system 140 or at another system) related to the image-item analysis module 250 receives requests to perform tasks using an input and generates a respective output. The tasks include, but are not limited to, natural language processing (NLP) tasks, audio processing tasks, image processing tasks, video processing tasks, and the like. In one or more embodiments, the machine-learned models used by the image-item analysis module 250 include one or more language models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed. The sequence of input tokens may also be referred to as a “prompt” or an “input” and the sequence of output tokens may be referred to as a “response” or “output” to the language model.

The computer model receives a request including input data (e.g., text data, audio data, image data, or video data) and encodes the input data into a set of input tokens. The machine-learned model is then applied to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), a second dimension of the tensor may represent a sample number in a batch of input data that is processed together, and a third dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. A LLM may be trained on massive amounts of text data, often involving billions of words or text units. The large amount of training data from various data sources allows the LLM to generate outputs for many tasks. An LLM may have a significant number of parameters in a deep neural network (e.g., a transformer architecture), for example, 1 billion, 15 billion, 135 billion, 175 billion, 500 billion, 1 trillion, 1.5 trillion or more parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service separate from the online concierge system 140. The LLM may be pre-trained by the online concierge system 140 or by one or more entities different from the online concierge system 140. A LLM may be trained on a large amount of data from various data sources. For example, the data sources may include websites, articles, posts on the web, and the like. The LLM is thus able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more embodiments, the transformer-based architecture may have an encoder-decoder architecture and includes a set of encoders coupled to a set of decoders. An encoder or decoder may include one or more attention operations.

While a LLM with a transformer-based architecture is described in one or more embodiments, in other embodiments, the language model can be configured as any other appropriate architecture including, but not limited to, long short-term memory (LSTM) networks, Markov networks, bidirectional auto-regressive transformers (BART), generative-adversarial networks (GAN), diffusion models (e.g., Diffusion-LM), and the like.

In one or more embodiments, the task for the language model is based on knowledge of the online concierge system 140 that is fed to the machine-learned model, rather than relying on general knowledge encoded in the model weights of the language model. Thus, one objective may be to perform various types of queries on data associated with the online concierge system 140, such as data relating to items available at the online concierge system. For example, the task may be to perform question-answering, text summarization, text generation, and the like, based on information contained in an item database stored in the data store 240. Relative to the language model, this information may represent “external data” in relation to more general parameters learned by the language model. In some configurations, rather than including the external data in the prompt, the language model may be configured to access relevant external data with an index or other data connectors to the external data, enabling the language model to retrieve relevant information in forming its response to the prompt. This may be useful, for example, when the data to be considered by the language model may exceed a prompt size limitation on the language model.

In one or more embodiments, the online concierge system 140 builds a structured index over the external data using, for example, another machine-learned language model or heuristics. The external data may include, for example, information about items stored at each physical location at which an order may be fulfilled (e.g., which may be stored at or determined from the data store 240). The image-item analysis module 250 may construct one or more prompts for input to the language model to use the language model to determine item-specific information or responses. As noted above, the prompt may also be referred to as “an input” to the language model. A prompt may include information about an item and/or a reference to the external item or other context that may describe external data and how to process it. In one or more embodiments, the context in the prompt includes information from or references to structured indices as contextual information for the query. For example, the structured indices may include information describing characteristics of items in a warehouse that may be structured for inclusion in the prompt to the language model. Such information may include, for example, an item's descriptions, brand, flavor information, size, price, allergen information, ingredients, ratings, item embedding, a representative image of the item, and so forth.

As such, in one or more embodiments, the item information from the item database may be included in the prompt (directly as tokens in the prompt or as a reference to the external data source) to focus the language model's processing on information about a particular item and to provide up-to-date information about the item. The language model may thus be used to process queries related to particular item(s) by including information about the other item(s) in the prompt, or otherwise providing a reference or link to item information (i.e., to the external data source) for the item information to be used in processing the prompt. As discussed below, the item information in conjunction with the language model may be used by the image-item analysis module 250 to analyze items in an image and provide natural language information to users about items in the image.

FIG. 3 is a flowchart for a method of automated item information assistance from an image, in accordance with one or more embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140), such as by an image-item analysis module 250. Additionally, each of these steps may be performed automatically by the online concierge system without human intervention.

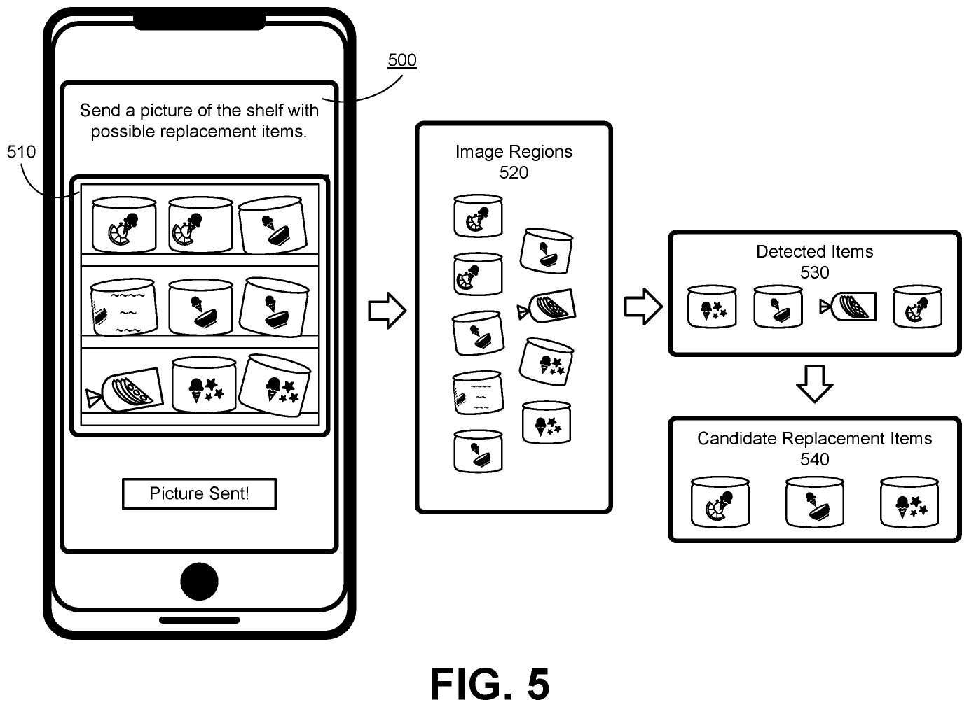

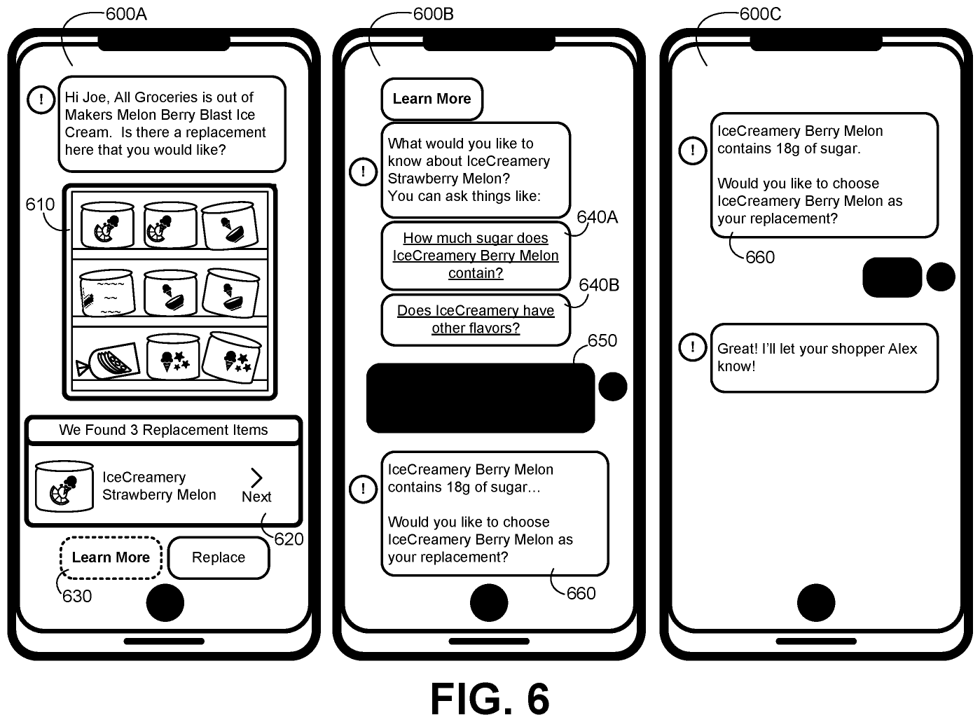

In general, the example flowchart shown in FIG. 3 provides an approach for improving user interactions with the online concierge system 140 with respect to item identification and information processing relevant to items in the image. As discussed in FIGS. 4-6, these approaches may be particularly beneficial to assist vision-impaired users or other users who may benefit from automated item identification and relevant information retrieval. As one example discussed with respect to FIG. 4, the approach may be used to aid a user (such as a vision-impaired user) in gathering information about delivered items in an order. In another example discussed with respect to FIGS. 5 and 6, this process may also be used to improve processes for identifying and selecting replacement items when a picker is at a physical warehouse, such that the picker may capture an image of items that may include replacement items, and the candidate replacement items are automatically identified and relevant information about the items may be efficiently determined and presented to another user selecting the replacement. Though discussed with respect to these examples, further embodiments include item identification and language model assistance related to the items in other contexts.

Initially, the online concierge system receives 300 an image for item information analysis. The image is typically of a physical space captured by a user device, such as a picker client device 110 at a warehouse or a customer client device 100. As such, in practice, the image may be captured by a user's device and sent for analysis, although other sources of the image data may also be used, such as other image analysis and user assistance operations. The image may include an unknown number of items to be identified and for which additional information is retrieved and intelligently processed for interactions with a language model.

To identify the items more accurately, a relevant item search space may be determined 310 based on a context of the image. The particular context may differ in different embodiments, and generally may be used to determine a set of possible items that may be in the image. The set of possible items is typically a subset of all items that may be identified, and represent, for example, a filter applied to an item database. The context may describe, for example, an order recently placed by a user, such that the possible items are the items included in the order. As another example, the context may describe a specific physical warehouse, such that the possible items are the items available at that particular physical warehouse (compared, for example, to items from the same retailer or brand that may not be available or stocked at that physical warehouse).

In a further example, the context may also be described in relation to another item that is not in the order. For example, the image analysis may be performed for the purpose of identifying candidate replacement items for an ordered item that is not available. In this instance, the context may describe the ordered item such that the possible items are limited to the items that may be suitable as replacements for the ordered item. As further discussed below with respect to FIGS. 5-6, when as the picker fulfills an order at the warehouse and item in the order may be unavailable, the picker may then capture an image of a portion of the warehouse with potential replacement items (and may also include items that are not suitable as a replacement). The context for identifying items in the image may then describe the ordered item and be used to narrow the possible items to those that may be considered as suitable replacements for the ordered item.

As such, the image may be associated with the context (or the context may otherwise be provided or determined) to determine the set of possible items that may be in the image. By determining a context and possible items in the search, identification of the items in the image may avoid erroneous matches with items known to the online concierge system but that, in view of the context, are not relevant or otherwise should not be identified in the image. In one or more embodiments, the item search space is not constrained to a particular context, such that the item search space may include possible items from the entire item database.

The image is then analyzed to detect 320 items in the image that match the possible items in the item search space. In some embodiments, an image segmentation algorithm may be applied to the image to identify separate items in the image and segment individual items from one another. Different image segmentation algorithms may be applied in different configurations and embodiments, and may include image segmentation algorithms trained on relevant items (i.e., items particular to the online concierge system or a particular set of items for the location). In the context of the online concierge system coordinating orders for grocery items, such items may include packaged items, such as ice creams, along with loose grocery items such as fresh produce, meats, and other types of items. The image segmentation algorithm in some embodiments may include processes trained on the particular items to be detected and may include identifying associated text or other language elements that may be identifiable on an item (e.g., on an item's label or packaging). As an item may be captured in the image from various perspectives, different aspects of the item may also vary at the different perspectives; from one perspective the item's name and label may be prominently viewable, while at another perspective the item's packaging may include only a portion of the item's name and different graphical elements. As such, determining the possible items in the image based on the image search space as discussed above may assist in correctly identifying the items in the image.

Using the portions of the image that may correspond to the possible items (e.g., regions of the image corresponding to the segmented objects in the image), items in the image are detected 320 from the set of possible items. The item detection process may vary in different embodiments and include any suitable object recognition and classification approach. These may include various ways of characterizing the segmented items in the image (e.g., the portions of the image) and comparing these characterizations to characteristics of the possible items. For example, the segmented image may be analyzed for particular features or keypoints of the image, described with respect to features as a whole, analyzed with text recognition with respect to a relationship between detected keypoints or other features in the segmented item, and so forth. In some embodiments, the item detection process may include processing by a language model (which can include multi-model analysis for processing input images) that receives the detected text and identifies a most likely item (or a relevance score) in the set of possible items. As one example, a prompt may be constructed for the language model based on item information of the possible items along with the text identified in the image to query the model for a likelihood that the text in the image corresponds to item described by the item identification.

In many cases, the image may include items that are not included in the set of possible items. For example, a user may capture an image of the user's table for identification of information about the items, and the captured image may include further items that are identified as a distinct item by the image segmentation algorithm. As such, regions of the image identified by the image segmentation algorithm may not correspond to any of the items in the set of possible items. In one or more embodiments, the segmented image region may be compared with one or more of the possible items to determine a score and/or likelihood that the segmented image region contains an item corresponding to the possible item. In addition to identifying a match between the segmented image region and one of the possible items based on the score(s), the scores may also be used to determine that there is no match between a segmented image region and any of the possible items.

In one or more embodiments, information about relative relationships and positions of the items in the image may also be determined from an analysis of the segmented regions in the image, for example, based on the relationship of the center of mass between image regions or other aspects of the detected items. Such relationships may describe, for example, that one item is above, below, left, right, on, under, or other another positional relationship relative to another item.

To further provide relevant information about the items, each of the identified items in the image (i.e., as matched to the possible items in the item search space) may be associated with related item information. The item information may be used to construct an input (i.e., a prompt) for the language model to extract relevant information about the item. The language model is queried 340 with the input, and the output of the language model is provided 350 to a user as a natural language output customized for the item. The particular structure for the input and the output may vary in different embodiments, and the user device that receives and displays the text-based output may differ from the user device that provided the image. In the example of a picker identifying a replacement item, the picker may identify an ordered item that is not available and capture the image on the picker's device, and the text-based output from the language model may be provided to the customer who placed the order for determining additional information about items that may replace the ordered item. In one or more embodiments, the text-based response from the language model may also be converted to another format, such as audio, for presentation to the user. For example, a text-to-speech algorithm may be applied to the output to generate associated speech corresponding to the natural language output. In some embodiments, the text-based output is provided in an interface as an interactive chat, such that the user may enter further questions related to the image and the detected item(s) within. As such, multiple inputs and related outputs may be generated as a part of an interaction with the language model.

The item information may be structured information about the item, such as its name, brand, item embedding, a description, reviews, and so forth. The item information may also vary according to the particular item type. For example, grocery items may include item information related to a particular flavor, alternate names for the item, nutritional information about the item, and so forth. The item information about an item may then be used to generate the input for the language model by including the item information in the prompt or by including a reference to the item information (e.g., as external data discussed above) for use by the language model. In some embodiments, a particular identified item is processed in one query, multiple items may be processed with separate queries, or multiple items may be processed in a single query. Item information for the related items of a particular query may then be included in the input for that query. Additional information may also be included, such as a particular situation/context in which the item is analyzed, or additional information about the image, such as information describing a relationship between relevant detected items in the image.

The input for the language model may include additional tokens that structure the overall prompt to the language model. For example, when a user provides a question, the input to the language model may include the user's prompt along with the item information and a structure or format that relates the two. For example, the structure or format may be: “Answer the question ‘[user question]’ for an item having the following characteristics: [item information].” As such, the structure may provide natural language context and direction to the language model relating the user's question to the item information of the detected item. The prompt may also include further information about the situation in which the question is posed, for example, including relational information about items in the image or additional information about other items.

The particular characteristics of the format and direction for the model may also differ in various embodiments. For example, in some embodiments, the language model may be queried with inputs about the detected items in anticipation of questions a user may ask, or to determine information that may be most relevant to the context. The language model may be queried, for example, with item information of a detected item and a prompt requesting identification of a question (or multiple questions) that a user may have about that item or about that item relative to other items. For example, an input to the language model may be: “What questions might a user have when considering replacing an item having these characteristics <ordered item characteristics> with an item having these characteristics: <detected item information>?” When the language model responds with relevant questions describing questions a user may have, the language model may then be separately prompted with those individual questions to determine the related answers. This permits the system to anticipate questions a user may have and surface particularly relevant information about detected items with natural language.

Together, the process shown in FIG. 3 provides a way for processing visual information (i.e., the image) to provide relevant natural language interactions with items in the image. Rather than a user specifying the relevant items and/or the relevant information about the items in an image, this process enables an automatic processing from an image to yield relevant information (that may not itself be present in the image) about the items presented in natural language interactions. By determining an appropriate item search space, detecting matching items is more likely to correctly identify the items in the image. Related item information is then automatically incorporated into the natural language processing with appropriate prompts, enabling the conversion of the image to a natural language interaction for the user with respect to the item information allowing a process for an image to readily generate relevant text (and optionally, speech) relating to the item that is informed by item information that is not present in the captured image, including anticipating relevant questions or areas for further evaluation by a user.

FIG. 4 shows an example interface 400 for providing item information assistance for an image 410 related to an order by a user, in accordance with one or more embodiments. In the example of FIG. 4, a customer may receive an order from a picker and wish to use the item detection and natural language processing to assist in distinguishing the items. This may be useful, for example, for a user with visual difficulties who may not be able to personally differentiate similarly-packaged items. The user may access an interface 400 by accessing an interface element on the device requesting visual assistance with items in the user's order. For example, after delivery of an order, the application executing on the user's device may display an interface element requesting feedback and offering assistance with the order, such that the user may elect to receive visual assistance with the delivered items for the user's order. The example of FIG. 4 shows an interface 400 of the customer's user device in which a user captures an image 410 having items 420A, B. In this example, the item 420A is a vanilla-flavored ice cream and item 420B is a berry melon-flavored ice cream. When the image is captured, the user may not know which item is which-while the user ordered different flavors, the packaging of the items may make it difficult to tell which item is which flavor without opening the packages. For many item types, opening the packages may not be preferable until the user expects to use the item (e.g., the items may spoil). For these reasons, the visual assistance and item detection may be useful for providing further item information related to the image to the user in combination with natural language inputs and outputs.

The image 410 captured by the user's device is sent to the online concierge system for detection of relevant items and to answer questions from the customer in the interface 400. In this example, the user enters the question 430 “Which ice cream is which?” in natural language. The online concierge system receives the image and the question from the user, detects items, and uses the language model to evaluate the user's request. In this example, the image and the user's request are provided to the online concierge system. Following the example of FIG. 3, the image is processed to determine image regions that may contain relevant items for the query. In this example, the context for determination of an item search space may be the order that was delivered to the customer, order 123, such that the possible items for detection in the image may be the items included in the customer's order. By limiting the possible items with the context of the user's order, the identified items are more likely to correctly correspond to the items actually in the image.

The question 430 is then provided with the item information of the detected item(s) to generate an input to the language model as discussed above, and may include relational information about the items in the image. For example, the input to the language model may be constructed with the identified item information by adding respective information to the prompt: “For a group of items having names and related characteristics of: <list of detected item names and related item information> positioned relative to each other as follows: <item relationship information” answer the question: <user input>” As such, the information about the detected items, relational information, and the user's question are structured as natural language for input to the language model, enabling the language model to evaluate the question with respect to the detected items without detailed user input, and output a natural language response 440 provided for display to the user. As shown in this example, this process allows the language model to determine relevant aspects of items in the image (i.e., the items have different flavors) and interpret the question to provide relational information about them as a natural language response (left and right).

In this example, the question 430 relates to all items in the image. The user may also select one or more detected items for which to ask the question. For example, the user may request a description of the identified items and then select one particular item for further interactions. The particular selected items by the user (e.g., whether the questions relate to the image as a whole or a particular item) may also affect the particular input to the language model used by the online concierge system. For example, when the user provides a question for the image as a whole, the input to the language model may include information about each of the items along with relational information about the items in the image (e.g., whether an item is above, below, to the left, right, etc. of another). When a user selects a particular item, the prompt may include the user's question and information about that item, such that the prompt to the language model may be modified according to the particular items selected by the user.

In this way, the online concierge system may provide additional information about items in an image by detecting items and providing supplemental information to a language model in a way that enables natural language inputs and outputs from the user's perspective.

FIGS. 5 and 6 provide an example flow and user interfaces for providing replacement item assistance from an image, in accordance with one or more embodiments. In this example, a picker at a physical warehouse identifies that an item may be unavailable for delivery. To aid in determining relevant replacement items, the picker may be prompted with an interface 500 on the picker's device to capture an image 510 of a region in the physical warehouse containing possible replacement items. In this example, the customer may have ordered an ice cream product that is not currently available, and the picker captures an image of a shelf at the warehouse containing potential replacements, such as other ice cream flavors. The picker's device sends the image to the online concierge system, which identifies image regions 520 that may correspond to items for which item information is available for the location. The image regions 520 are determined, for example, with an image segmentation algorithm as discussed above. In this example, the item search space may be the items available at the warehouse. In a further configuration, the item search space may also be limited to items that may be relevant as replacement items to the item ordered by the customer.

As shown in the image 510 and the detected image regions 520, the physical items captured in the image may be viewed from various perspectives as discussed above. In this example, when items are detected from the image regions 520, the detected items 530 may be de-duplicated, such that image regions that are identified as the same item may not result in additional detected items. In this instance, as the customer is selecting a replacement item, it may not be relevant to determine the number of items available at the warehouse. In other examples, the quantity of each item detected in the image may be determined. In this example, the detected items may also be processed to determine which of the detected items may be suitable candidate replacement items 540 for the item that was ordered by the user. The detected items 530 may be scored or otherwise evaluated as replacement items in a variety of ways. In one or more embodiments, a computer model that scores replacement items may be applied to score each of the detected items with respect to the ordered item, such that items having a threshold score or a number of highest-scoring items (e.g., the top n items) are selected as candidate replacement items 540. In this example, the detected items 530 include three flavors of ice cream and a bag of peas. When evaluated as a candidate replacement item for the ordered item (an ice cream), the peas may have an insufficient score and are not included in the candidate replacement items. As such, additional steps may also be included for selecting detected items for use with the language model (here, evaluation of the detected items with respect to replacement of the ordered items). In some embodiments, the selection of candidate replacement items may also be based on the language model inputs, for example, by providing a prompt and item information related to the ordered item and the detected items and requesting the language model to determine relevant items as replacements for the ordered item.

The candidate replacement items 540 and information about them may be presented to the customer on a user device as shown in FIG. 6. In the example of FIG. 6, the user device may be operated by a customer who placed the order being fulfilled by the picker. The customer may view a series of interfaces 600A-C showing information about the candidate replacement items and enabling interactions to obtain further natural language information about the replacement items. Initially, the interface 600A may show the user the image 610 taken by the picture, along with information about the detected items in the image (here, as items for replacement). In this example, the detected replacement items in the image 610 are displayed to the user along with an interface element 620 to select a replacement item and another interface element 630 to learn more about the replacement item.

When the user selects the interface element 630 to learn more, the user is presented with an interface for interacting with the language model in natural language (e.g., with questions). In this example, the interface elements include questions 640A-B that are pre-populated by the online concierge system. That is, the questions 640A-B are generated by the online concierge system by providing information about the item to the language model as an input with a query that requests one or more questions that a user may have about the replacement item. This permits the user to readily navigate and obtain additional information about the item with suggestions provided by the language model customized to the item information. The user may then select one of the questions 640A-B or enter another natural language input for interaction with the language model. In this example, the user selects question 640A and is provided as the user's input 650. A response 660 to the question may then be generated by the language model as discussed above and presented to the user, enabling the user to decide whether to accept or reject the candidate replacement item as shown in interface 600C. The interfaces and other text may also be read to the user, e.g., with text-to-speech, and users may provide input with voice commands, such that the natural language that may be native to the user is easily input to and received from the user's device.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example; comparing an output of the machine-learning model to the label associated with the training example; and updating weights associated for the machine-learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method performed at a computer system comprising a processor and a computer-readable medium, the method comprising:
receiving an image for item information analysis, the image including image regions corresponding to unknown items in the image;
identifying a context of the received image;
generating, based on the context of the image, an item search space including a set of possible items in the image;
identifying a set of detected items as a subset of the set of possible items in the image based on the image regions;
identifying, for a detected item in the set of detected items, item information from an item database for the detected item describing characteristics of the detected item;
querying a language model with an input based on the item information about the detected item; and
sending an output of the language model to a user device for display to a user.

2. The method of claim 1, wherein identifying the context of the received image comprises receiving a request from a user for delivered items, wherein the context includes the request and the set of possible items include a set of items from an order delivered to the user.

3. The method of claim 1, wherein identifying the context of the received image comprises determining a replacement item for an unavailable item in an order, wherein the set of possible items include a set of stocked items in a warehouse at which the image was captured.

4. The method of claim 1, wherein the querying comprises prompting the language model with structured item information about the detected item and a request to analyze the structured item information.

5. The method of claim 4, wherein prompting the language model comprises requesting identification of a question a user may have about the detected item.

6. The method of claim 5, wherein the output of the language model describes a question, and the method further comprises:
determining an answer to the question from the language model based on the question and the item information; and
providing the answer to the user device for display to the user responsive to the user selecting the question.

7. The method of claim 1, wherein identifying the set of detected items comprises performing a nearest-neighbor search.

8. A non-transitory computer readable medium storage having instructions encoded thereon that, when executed by a processor, cause the processor to perform steps comprising:
receiving an image for item information analysis, the image including image regions corresponding to unknown items in the image;
identifying a context of the received image;
generating, based on the context of the image, an item search space including a set of possible items in the image;
identifying a set of detected items as a subset of the set of possible items in the image based on the image regions;
identifying, for a detected item in the set of detected items, item information from an item database for the detected item describing characteristics of the detected item;
querying a language model with an input based on the item information about the detected item; and
sending an output of the language model to a user device for display to a user.

9. The non-transitory computer readable medium storage of claim 8, wherein identifying the context of the received image comprises receiving a request from a user for delivered items, wherein the context includes the request and the set of possible items include a set of items from an order delivered to the user.

10. The non-transitory computer readable medium storage of claim 8, wherein identifying the context of the received image comprises determining a replacement item for an unavailable item in an order, wherein the set of possible items include a set of stocked items in a warehouse at which the image was captured.

11. The non-transitory computer readable medium storage of claim 8, wherein the querying comprises prompting the language model with structured item information about the detected item and a request to analyze the structured item information.

12. The non-transitory computer readable medium storage of claim 11, wherein prompting the language model comprises requesting identification of a question a user may have about the detected item.

13. The non-transitory computer readable medium storage of claim 12, wherein the output of the language model describes a question, and wherein the instructions further cause the processor to perform steps comprising:
determining an answer to the question from the language model based on the question and the item information; and
providing the answer to the user device for display to the user responsive to the user selecting the question.

14. The non-transitory computer readable medium storage of claim 8, wherein identifying the set of detected items comprises performing a nearest-neighbor search.

15. A computer program product, comprising:
a processor that executes instructions; and
a non-transitory computer readable storage medium having instructions executable by the processor for:
receiving an image for item information analysis, the image including image regions corresponding to unknown items in the image;
identifying a context of the received image;
generating, based on the context of the image, an item search space including a set of possible items in the image;
identifying a set of detected items as a subset of the set of possible items in the image based on the image regions;
identifying, for a detected item in the set of detected items, item information from an item database for the detected item describing characteristics of the detected item;
querying a language model with an input based on the item information about the detected item; and
sending an output of the language model to a user device for display to a user.

16. The computer program product of claim 15, wherein identifying the context of the received image comprises receiving a request from a user for delivered items, wherein the context includes the request and the set of possible items include a set of items from an order delivered to the user.

17. The computer program product of claim 15, wherein identifying the context of the received image comprises determining a replacement item for an unavailable item in an order, wherein the set of possible items include a set of stocked items in a warehouse at which the image was captured.

18. The computer program product of claim 15, wherein the querying comprises prompting the language model with structured item information about the detected item and a request to analyze the structured item information.

19. The computer program product of claim 18, wherein prompting the language model comprises requesting identification of a question a user may have about the detected item.

20. The computer program product of claim 19, wherein the output of the language model describes a question, and wherein the instructions are further executable for:
determining an answer to the question from the language model based on the question and the item information; and
providing the answer to the user device for display to the user responsive to the user selecting the question.
